(19) United States
(12) Patent Application Publication
(10) Pub. No.: US 2026/0139666 A1
(43) Pub. Date: May 21, 2026

(54) SYSTEM FOR CLEARING AIRLOCK PREVENTION HOLE

(71) Applicant: Ashland Water Group, Inc., Ashland, OH (US)

(72) Inventors: James M. Linder, Ashland, OH (US); Joseph R. Pinto, Scottsdale, AZ (US); Dou Shulin, Ashland, OH (US); Jason J. Davis, Polk, OH (US)

(73) Assignee: Ashland Water Group, Inc., Ashland, OH (US)

(21) Appl. No.: 19/390,829

(22) Filed: Nov. 17, 2025

Related U.S. Application Data
(60) Provisional application No. 63/721,073, filed on Nov. 15, 2024.

(51) Int. Cl. F04B 53/06; B08B 9/043

(52) U.S. Cl. CPC F04B 53/06; B08B 9/0436

(57) ABSTRACT

One or more techniques and/or systems are disclosed for a clearing system designed for use within a pump to enhance maintenance efficiency and operational reliability. The clearing system may be integrated into a pump housing and specifically configured to address blockages in a weephole to mitigate airlock within the pump's inner chamber. This system may include a plunger mechanism, which is actuated by a user-operated button member. Upon activation, the plunger extends into the weephole to clear any obstructions, thereby maintaining the essential flow and pressure balance required for optimal pump performance.

### CROSS-REFERENCE TO RELATED APPLICATIONS

This application claims priority to U.S. Ser. No. 63/721,073, entitled SYSTEM FOR CLEARING AIRLOCK PREVENTION HOLE, filed Nov. 15, 2024, which is incorporated herein by reference.

### BACKGROUND

In the field of pump technology, a common operational issue is the occurrence of air-locking within a pump. An air-lock occurs when air becomes trapped within the volute or pumping housing, impeding the pump's ability to function properly by preventing the intended liquid medium from being pumped effectively. This trapped air prevents the liquid from filling the pump fully, thus stopping the pump from operating as designed until the air is expelled and replaced by the liquid medium. To mitigate the risk of air-locking, an airlock prevention hole is commonly incorporated into the design of the volute or pumping housing. This hole is typically positioned to allow any trapped air to be displaced by the pumping medium, facilitating continuous and effective pump operation. The presence of this small hole allows the air to escape, thereby maintaining the integrity of the pumping process. However, the airlock prevention hole or weephole can also become obstructed by debris, which leads to the same air-locking issue it is meant to prevent, requiring disassembly of the outer housing of the pump and cleaning of the airlock prevention hole.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are described herein for a clearing system designed for use within a pump system to enhance maintenance efficiency and operational reliability. The clearing system may be integrated into a pump housing and specifically configured to address blockages in a weephole to mitigate airlock within the pump's inner chamber. This system may include a plunger mechanism, which is actuated by a user-operated button member. Upon activation, the plunger extends into the weephole to clear any obstructions, thereby maintaining the essential flow and pressure balance required for optimal pump performance.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1A is a front view of an example pump housing where one or more portions of one or more techniques and/or one or more systems described herein may be implemented.

FIG. 1B is a cross-sectional view of an example pump housing where one or more portions of one or more techniques and/or one or more systems described herein may be implemented.

FIG. 2A is an isometric cross-sectional view of an example clearing system where one or more portions of one or more techniques and/or one or more systems described herein may be implemented.

FIG. 2B is an isometric cross-sectional view of an example clearing system where one or more portions of one or more techniques and/or one or more systems described herein may be implemented.

FIG. 3 is an isometric phantom view of an example clearing system integrated into a pump housing where one or more portions of one or more techniques and/or one or more systems described herein may be implemented.

FIG. 4 is an isometric view of an example clearing system where one or more portions of one or more techniques and/or one or more systems described herein may be implemented.

FIG. 5 is an isometric, phantom view of an example clearing system where one or more portions of one or more techniques and/or one or more systems described herein may be implemented.

FIG. 6 is a side view of an example clearing system where one or more portions of one or more techniques and/or one or more systems described herein may be implemented.

FIG. 7 is a side, phantom view of an example clearing system where one or more portions of one or more techniques and/or one or more systems described herein may be implemented.

FIG. 8 is a side, cross sectional view of an example clearing system where one or more portions of one or more techniques and/or one or more systems described herein may be implemented.

FIG. 9 is a side, cross sectional view of an example clearing system where one or more portions of one or more techniques and/or one or more systems described herein may be implemented.

FIG. 10 is a cross sectional view of an example pump housing where one or more portions of one or more techniques and/or one or more systems described herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Described herein is an apparatus/device/system and method that provides for clearing of an air lock prevention system disposed in a pump. That is, for example, pumps can comprise a volute, or the like, that is operably disposed in a liquid, and the liquid within the volute is discharged by the pump. However, when the volute contains air, an air lock condition can occur, which prevents effective discharge of the liquid by the pump. In order to mitigate this air-lock condition a weephole, or the like, is disposed in the housing of the volute or pump that allows fluid (including air and water) to pass between the volute and the outside environment to the volute. This weephole can mitigate the air-lock condition by allowing air to escape and/or liquid to enter the volute. However, debris that may be entrained in the target liquid and the debris can occasionally obstruct the weephole, thereby effectively reducing its effectiveness. As described herein, a system is configured to help clear a potential blockage from such a weephole in order to maintain the effectiveness of the weephole.

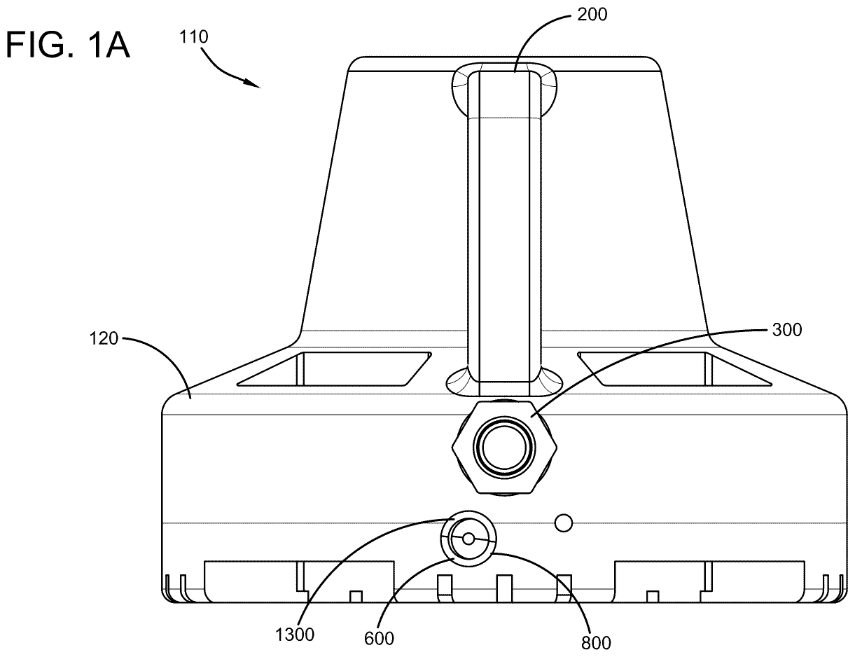

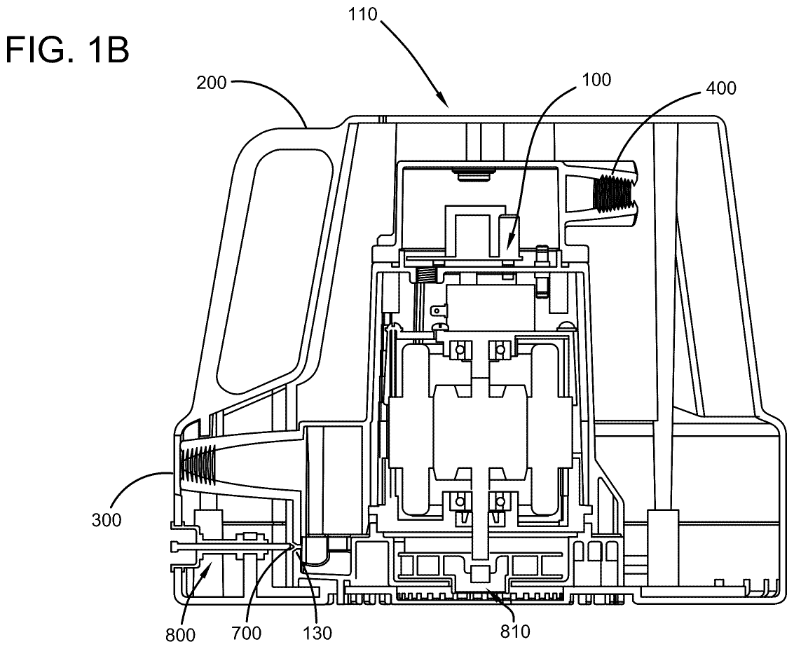

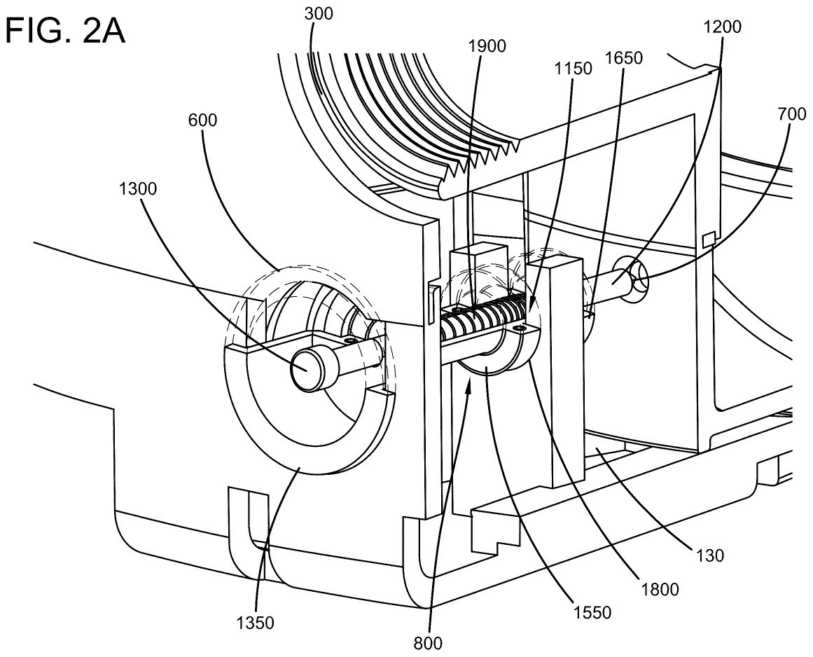

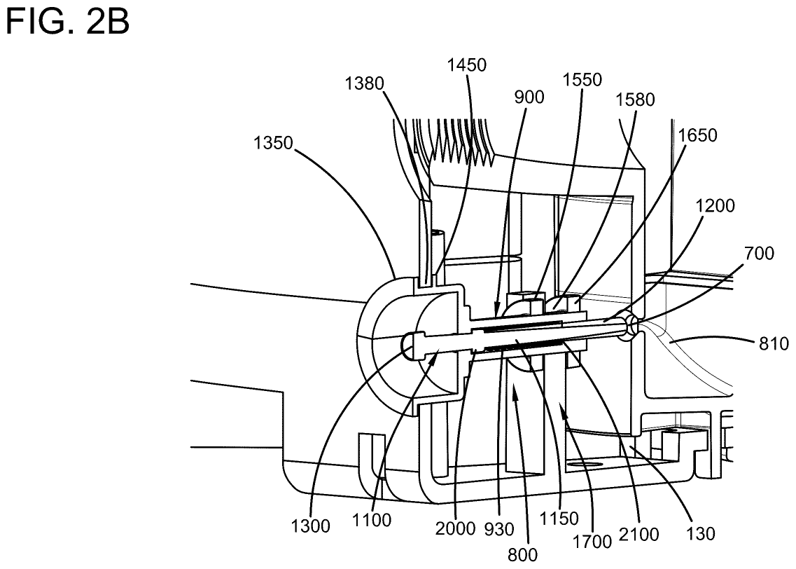

Turning to FIGS. 1A, 1B, 2A, and 2B, in one example of an environment in which the disclosed system may be implemented, a pump housing 110 may include an outer surface 120, and a handle 200 disposed on the outer surface 120. Further, a pump 100 disposed in the housing 110 may comprise a discharge port 300 leading to the outer surface 120, and extending inside the pump housing 110 in fluid communication with an inner chamber 130, wherein the discharge port 300 is configured to be coupled to a hose, or may discharge to another fluid system. For example, the discharge port 400 may be coupled to the piping (e.g., a hose, pvc pipe, tubing, metal pipe) via various securing methods including but not limited to threading, clamping, cam and groove couplings, IBC couplings and lever lock water couplings. The discharge port 300 may be in downstream fluid communication with a pump chamber 810, via the inner chamber 130, wherein the discharge outlet 300 allows the operating fluid to exit the pump 100. Furthermore, the pump housing 110 may contain an actuator opening 600 with a radius on the outer surface 120. One example of the disclosed clearing system 800 may be disposed in, integrated to, or coupled to the actuator opening 600 by using fasteners or other mounting hardware, or other fastening means (e.g., glue, friction fit, welding, etc.) designed to securely connect and align the components. A power (e.g., electrical) supply entry 400 may be disposed at a top portion of the pump 100, and may provide an entry location for a power cord, for example, through the housing 110 to the pump 100.

The inner chamber 130 may further comprise a weephole 700 in downstream fluid communication with the discharge port 300 such that, during operation, fluid may escape or seep out of the weephole 700 to regulate pressure or mitigate airlock in the inner chamber 130 (e.g., in some examples, fluid may enter through the weephole, such as into the inner chamber 130). This pressure regulation (e.g., airlock prevention) function helps to mitigate pump operation failure and, in some implementations, can be used to provide notification or warning when pump seals are under high pressure conditions for purposes of replacement or maintenance. In some implementations, the clearing system 800 can be used to clear the weephole 700 if it is clogged (e.g., partially or fully) to manage fluid ingress and maintain pressure differentials within the system by facilitating the controlled release of accumulated fluids, pressure, or particulates during operation. In some implementations, the pump 100 can further comprise a pump chamber 810 (e.g., fluid inlet) located inside the pump 100 wherein the pumping chamber 810 is located inside both the pump 100 and the inner chamber 130. In such implementations, the inner chamber 130 can be located outside of the pump 100 and inside of the inner chamber 130 of the pump housing 110. Furthermore, in implementations the weephole can be in fluid communication between the pump chamber 810 and the inner chamber 130.

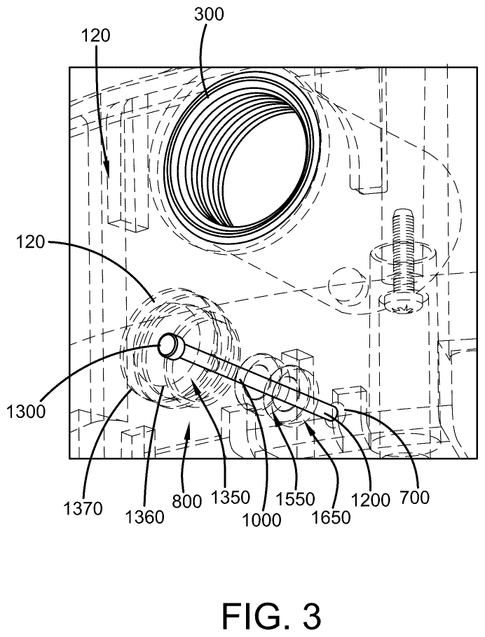

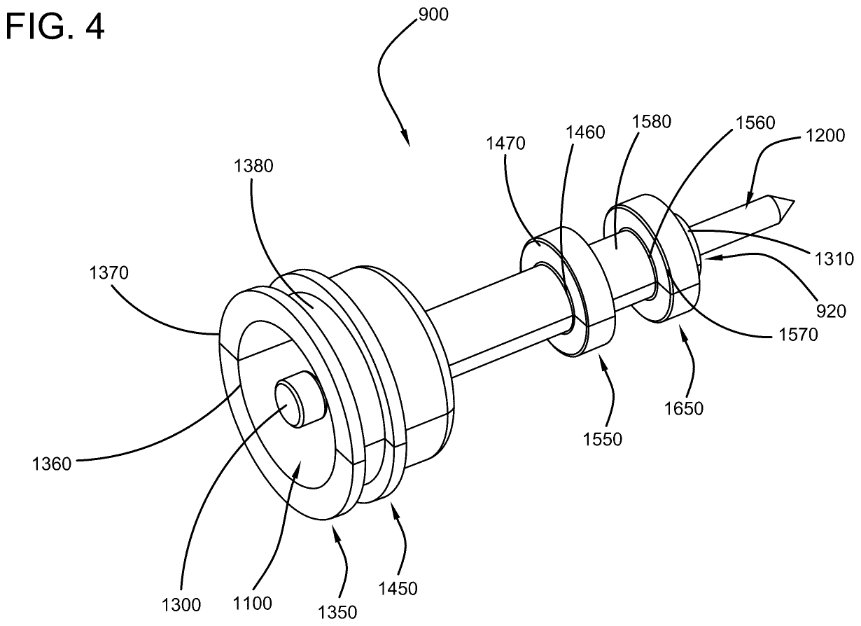

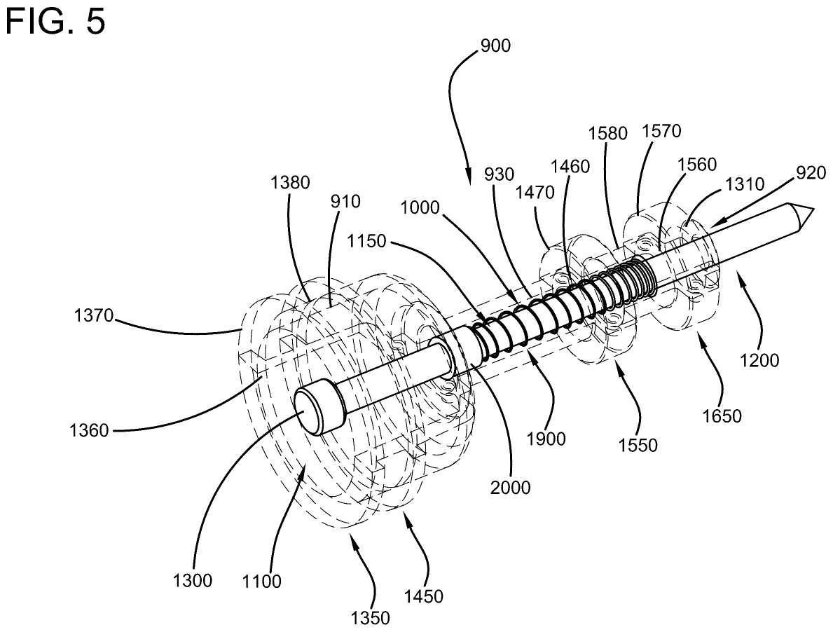

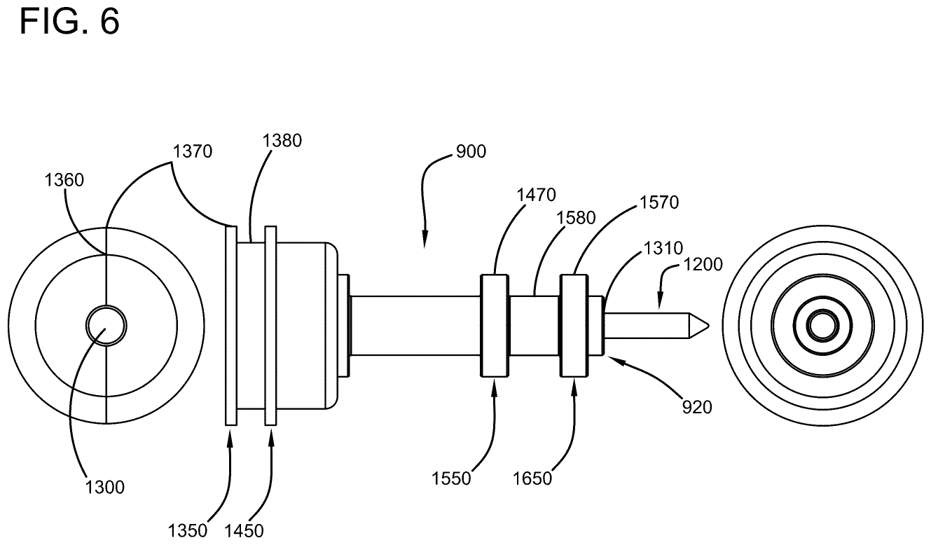

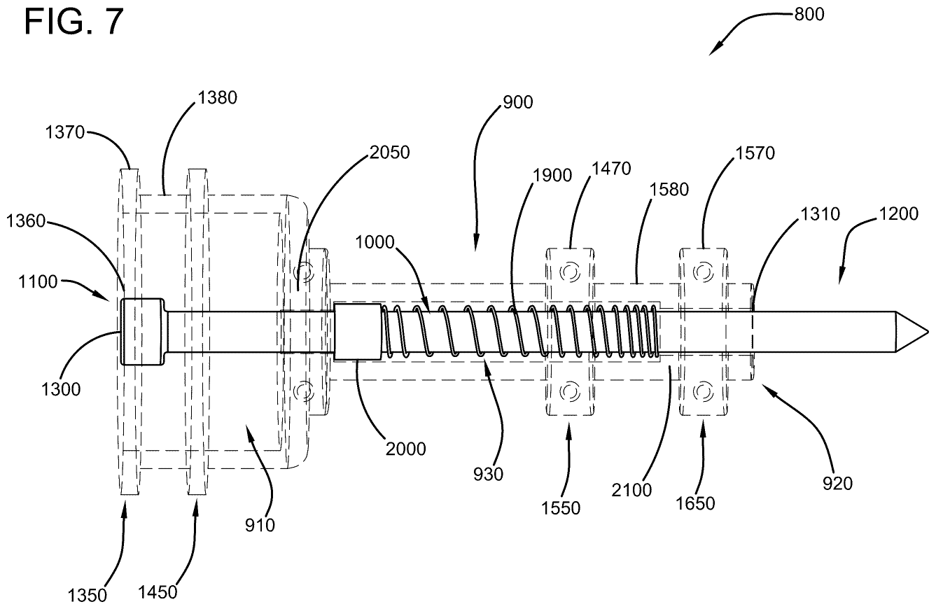

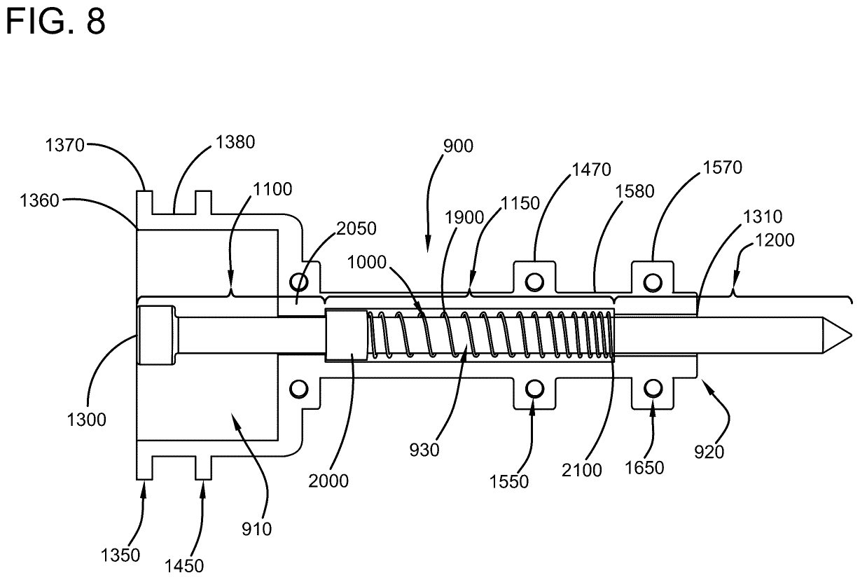

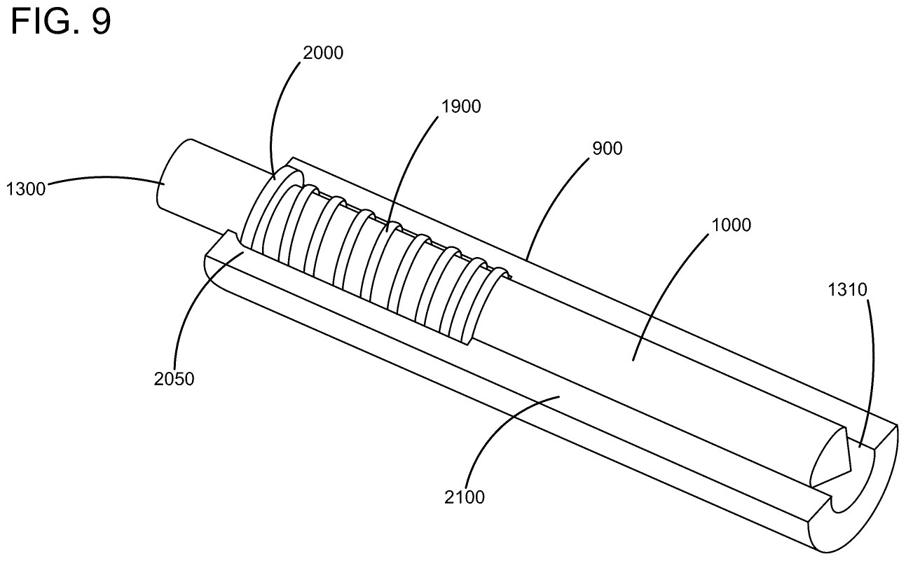

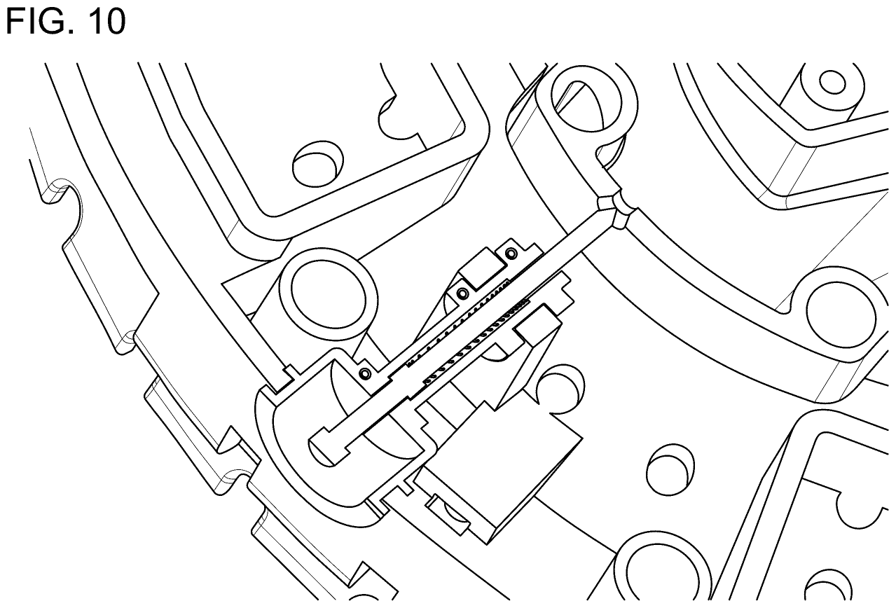

Turning to FIGS. 3, 4, 5, 6, 7, 8, 9, and 10 in some implementations, the clearing system 800 can comprise a plunger chamber housing 900 (e.g., a body of the clearing system) with a proximal first end 910, a distal second end 920, a chamber 930, and a plunger 1000 disposed in the chamber 930 of the plunger chamber housing 900, wherein the plunger 1000 has a plunger first end 1100, a plunger body 1150, and a plunger distal end 1200. An actuator 1300 (e.g., button member or an actuator of any practical type) can be disposed at the plunger first end 1100 to initiate and actuate a translation of the plunger, such as in a telescopic movement, toward the distal end 1200. In some implementations, the plunger 1000 may be elongate and disposed at least partially in the body, such that when the plunger is actuated the distal end 1200 of the plunger 1200 engages with the weephole. Furthermore, in several implementations, during actuation the plunger 1000 can translate through or extend along a distal opening 1310 at the distal end 920 such that a portion of the plunger 1000 may translate through the distal opening 1310 at the distal end 920 when the button member 1300 is depressed. In this example, this plunger translation along its central axis can result in a portion of the distal end 920 extending into (e.g., and at least partially through) the weephole 700, to mechanically clear a potential obstruction therein. In this way, for example, the operational integrity of the weephole 700 can be maintained. That is, for example, the portion of the distal end 1200 can comprise a tip that is configured (e.g., shaped and sized, for example, pointed) to effectively engage with the weephole to mechanically disrupt, dislodge, pulverize, or otherwise remove entrapped debris form the weephole 700.

In some implementations, the plunger chamber housing 900 may at least partially function as a structural frame or shell for the clearing system 800 such that the housing 900 substantially encloses or contains at least a portion of the plunger 1000 and its associated components therewithin. The plunger chamber housing 900 may be fabricated from materials such as durable polymers, metals, or composites that provide appropriate strength and corrosion resistance. The plunger chamber housing 900 can include external flanges, threads, or clips that enable a coupling or an operable secured connection to the pump housing 110 to facilitate alignment of the clearing system 800, along with desired stability during both routine operation and under varying operational conditions in the pump system. For example, in some implementations, the button member 1300 can be located proximate to the first end 910, wherein the button member 1300 is at least partially surrounded by a first collar 1350, the first collar having an internal radius 1360 and an external radius 1370 extending radially outward from the exterior surface of the plunger chamber housing 900, wherein the external radius is larger than the radius 610 of the actuator opening 600. In this way, for example, the clearing system 800 can be appropriately coupled and secured to the pump housing 110 during operation. Further, the exterior surface of the plunger chamber housing 900 may further comprise a first neck 1380 adjacent to the first collar 1350, the first neck 1380 having an external radius that matches or is slightly smaller than the radius 610 of actuator opening 600. Further, a second collar 1450 may be located adjacent to the first neck 1380 and distally from the first collar 1350. The second collar can comprise an internal radius 1460 and an external radius 1470 extending radially outward from the exterior surface of the plunger chamber housing 900. The external radius 1470 can be larger than the radius 610 of the actuator opening 600 in the pump housing 110 in order to provide for coupling the clearing system 800 to the pump housing 110 during operation.

In a further implementation, the clearing system 800 can further comprise a third collar 1550, the third collar having an internal radius 1560 and an external radius 1570 extending radially outward from the exterior surface of the plunger chamber housing 900. The clearing system 800 can further comprise a second neck 1580 with an external radius 1590. The second neck can be disposed adjacent to, and distally from, the third collar 1550. In addition, the clearing system 800 can further comprise a fourth collar 1650, the fourth collar having an internal radius 1660 and an external radius 1670 extending radially outward from the exterior surface of the plunger chamber housing 900. The fourth collar 1650 can be disposed adjacent to, and distally from, the second neck 1580. Further, in some implementations (e.g., as depicted in FIG. 2B), an internal housing mount 1700 can be disposed within the pump housing 110. In these implementations, the internal housing mount 1700 can be coupled to the clearing system 800 at the second neck 1580, disposed between the third collar 1550 and the fourth collar 1650 in connected engagement with the second neck 1580. In such an implementation, the internal mount 1700 can have a mount opening 1800 with a radius at least as large as the external radius 1590 of the second neck 1580 but smaller than the external radius of the third and fourth collars (1550, 1650). When coupled to the internal mount 1700, the third collar 1550, second neck 1580, and fourth collar 1650 may help secure the plunger chamber housing 900 to the housing 110, and thus the clearing system 800 to the pump housing 110 during operation.

In some implementations, to assist in the functionality of the plunger 1000, a biasing element, such as a spring 1900, may be disposed within the plunger chamber housing 900 and configured to normally bias the plunger 1000 in a proximal direction (e.g., away from the weep hole 700). For example, the spring 1900 may mechanically and elastically link the plunger 1000 to the plunger chamber housing 900. In operation, the spring 1900 normally biases the plunger 1000 to a retracted position (e.g., retracted away from the weep hole 700), and allows for extension (e.g., toward the weep hole 700) when a force that overcomes the biasing force of the spring 1900 is applied to the button member 1300 in a distal direction.

As illustrated, the plunger body 1150 may comprise a first plunger spring retention collar 2000 extending radially outward from the plunger body 1150. In this implementation, the radius of the first plunger spring retention collar 2000 is smaller than that of the internal radius of the chamber 930 but larger than the internal radius of the spring 1900. Further, the chamber 930 of the plunger chamber housing 900 may also comprise a first chamber retention collar 2050, extending radially inward from the inner surface of the chamber 930. In this implementation, the internal radius of the first chamber retention collar 2050 is larger than the radius of plunger body 1150, and smaller than the internal radius of the first plunger spring retention collar 2000. Similarly, the distal end of the chamber 930 of the plunger chamber housing 900 may comprise a second chamber retention collar 2100. The second chamber retention collar 2100 extends radially inward from the inner surface of the chamber, wherein the internal radius of the second chamber retention collar 2100 is larger than the radius of plunger body 1150, and smaller than the external radius of the spring 1900. During operation, when in a normal position, the points of contact (e.g., support) from the first end to the distal end are as follows: the first chamber retention collar 2050 may be in contact with the first plunger spring retention collar 2000, which is contact with the spring 1900, which is in contact with the second chamber retention collar 2100.

It is anticipated that other implementations may be utilized, which may vary the geometry from a compression spring to a tension spring to accomplish the same mechanical function. For example, the spring may be securely fixed and attached to the plunger chamber housing 900 and the plunger 1000 and during operation may be extended under tension when the button member 1300 is pushed or the plunger is subject to translational motion. In other implementations, a magnet may provide the biasing force used for the plunger in a similar fashion as the spring described above. The magnet may comprise an electromagnet, a temporary magnet, and/or a permanent magnet. For example, the magnet may include, but is not limited to, various materials and types such as neodymium, samarium cobalt, alnico, ceramic, ferrite, solenoid, alnico, strontium-iron, neodymium-iron-boron, and samarium-cobalt. Further, as an example, the actuator 1300 (e.g., button member) may comprise a lever, a rotating member (e.g., with a threaded plunger 1000), an automated actuator engaged with the first end 1100 of the plunger 1000, or other structure that is effective to drive a tip of the distal end 1200 of some style of plunger 1000 into the weephole 700 to clear debris.

In some implementations, the clearing system 800 may be equipped with an integrated mounting system designed for quick detachment and reattachment of the plunger chamber housing 900, facilitating easy maintenance and component replacement without requiring specialized tools. By way of example, one such mounting system may comprise a twist lock that ensures a secure yet easily removable connection between the plunger chamber housing 900 and the pump housing 110 via a rotating collar. For ease of operation, a release button may be incorporated to allow the twist lock to be quickly disengaged. Furthermore, alignment indicators may be implemented to help ensure that reattachment is correct. During operation, the plunger chamber housing 900 may be inserted into a receptor and the rotating collar twisted to secure the plunger chamber housing 900 in place. Other implementations may utilize releasable clamps or other similar coupling fastener to attach and detach the plunger chamber housing 900.

During operation, the clearing system 800 may help to maintain the pump 100 system's efficiency by mitigating air-lock conditions that may occur when a weep hole becomes blocked. For example, when the button member 1300 is actuated, the plunger 1000 translates distally, extending laterally to engage and clear the weephole 700. In this example, the subsequent retraction of the plunger, aided by the spring 1900, provides for the system to be ready for another cycle of operation without a need to take the pump or pump housing 110 apart to manually remove a clogged weephole 700.

In some implementations, the plunger 1000 may be cylindrical, however the cross-sectional shape may vary (e.g., circular, rectangular, conical, pyramidal). Typically, the cylindrical shape facilitates smooth telescopic movement within the chamber 930. The material selection for the plunger body 1150 may include stainless steel or reinforced polymer, chosen for durability, strength, and resistance to wear. The plunger distal end 1200 may be pointed, scooped, ribbed, threaded, hooked or of other similar geometry. In some implementations, the plunger distal end 1200 may be composed of a hard, wear-resistant material such as polycarbonate, ABS, stainless steel, nickel, carbon steel, aluminum, copper, or other suitable material able to withstand repeated use and corrosion. The plunger distal end 1200 may be of different material composition than the other parts of the plunger 1000 to optimize clearing effectiveness and longevity. Furthermore, the distal end 1200 may further include a micro-abrasive tip to grind away mineral deposits or other tough clogs within the weephole 700.

In some implementations, the button member 1300 may be located at the plunger first end 1100 of the plunger 1000 wherein the button may allow for manual translation of the plunger 1000, resulting in a retractable telescoping effect during operation. In such implementations, the button member 1300 may be ergonomically designed to facilitate easy actuation (e.g., pressing) and may be composed of a hard, wear-resistant material such as polycarbonate, ABS, stainless steel, nickel, carbon steel, aluminum, copper, or other suitable material able to withstand repeated use. In some implementations, the button may be a slightly convex shape with smooth, rounded edges. In other implementations, the button may be concave in shape to comfortably fit the curvature of the fingertip for better pressure distribution.

In other implementations, the clearing system 800 (e.g., and/or the plunger 1000) may be oriented or of a geometry such that pulling the plunger, as opposed to pushing the plunger, may provide for clearing of the weephole 700 during operation. In this implementation, the actuation would involve pulling instead of pushing and therefore would utilize a tension spring instead of a compression spring (e.g., biasing proximally), a pull knob instead of a push button, and a plunger end positioned in the chamber beyond the weephole 700 when the clearing system 800 is in a normal position. Furthermore, it is anticipated that a hybrid of the push and pull clearing assemblies may also be implemented, wherein both a push phase and a pull phase may be used to clear a clogged weephole 700.

In other implementations, the clearing system mechanism responsible for actuating movement of the plunger may be of various types separate from a manual spring. In some implementations an automatic actuator may be used to move the plunger. The actuator may be electromechanical wherein after the button is depressed and/or a switch is activated, the plunger is moved by a motor in electrical communication with the button or switch. In implementations, the actuator may be an electromagnetic, magnetic, pneumatic, hydraulic, or other similar actuator type. In implementations using non-hydraulic or pneumatic electric actuators, the actuator may be brushed, brushless, direct drive, linear, servo, stepper, or other similar electric type. Furthermore, the motion of the plunger may be rotational as well as translational to improve unclogging effectiveness.

In some implementations, the automatic actuator may be configured such that during operation the plunger engages following a user input (e.g., pushing a button or flipping a switch). Alternatively, the automatic actuator may be configured to automatically engage under predetermined operating conditions without user input. By way of illustration, fluid mechanic conditions could actuate the device when there is a reduction in flowrate, or a measured increase in pressure. For example, in some implementations a mechanical or electrical pressure switch may be in electronic communication with the clearing system actuator such that during operation a signal is transmitted from the switch to the clearing system actuator to engage the plunger. Alternatively, a flow gauge may be utilized in a similar fashion to automatically engage the plunger during periods of reduced flowrate.

In some implementations that utilize electricity to power the clearing system, the clearing system 800 may be in electrical communication with an alternative current power supply. In other implementations the clearing system 800 may be powered by batteries. The battery composition may include lithium-ion, nickel-cadmium, nickel-metal hydride, lithium-ion-polymer, silver oxide, zinc-carbon, alkaline, sodium-sulfur, flow batteries or other battery types. Similarly, during operation the clearing system 800 may operate while plugged in (e.g., to the pump or other AC source) or while unplugged. When the clearing system is plugged in, an AC adapter converts the AC power to DC, a power management controller in electrical communication with the AC adapter receives the DC power and ensures that enough power is available to operate the clearing system. In some implementations, after operational demands are met, any excess power is routed to a battery charger circuit. The charger circuit may also regulate the power flow from an outlet to recharge the battery safely, all while being monitored by a battery management system. When there is no AC power from an outlet being provided, such as the case when the clearing system 800 is unplugged, a switching mechanism automatically disconnects the clearing system from the external power source and the tool then switches to battery mode, drawing power from the internal batteries to continue its operation.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A pump system, comprising:
a pump housing including an outer surface, an inner chamber, and a suction inlet port on the outer surface extending into the pump housing in fluid communication with the inner chamber;
an opening in the outer surface of the pump housing;
a weephole disposed in a wall of the inner chamber in fluid communication with the suction inlet port; and
a weephole clearing system operably fixed in the opening, the clearing system comprising a body and elongated plunger disposed at least partially in the body, such that when the plunger is actuated a distal end of the plunger engages with the weephole.

2. The pump system of claim 1, wherein the distal end of the elongated plunger operably extends through the weephole to clear obstructions.

3. The pump system of claim 2, wherein the elongated plunger is constructed from a corrosion-resistant material, including options such as stainless steel, nickel, or reinforced polymer, to withstand frequent exposure to operating fluids and environmental conditions.

4. The pump system of claim 2, wherein the clearing system further comprises a spring disposed within a plunger chamber housing, wherein the spring biases the plunger into a retracted position under non-operational conditions.

5. The pump system of claim 2, wherein the clearing system is configured with a manually operable button member at a first end of the plunger to initiate a telescopic engagement of the elongated plunger into the weephole.

6. The pump system of claim 2, wherein the clearing system further includes a sensor configured to detect clogging or excessive pressure within the weephole, and upon detection, automatically activates the plunger to clear an obstruction.

7. A clearing system for a pump, comprising:
a plunger chamber housing including a chamber and a plunger at least partially disposed within the chamber;
a button member disposed at a first end of the plunger to initiate movement of the plunger; and
a plurality of collars and necks on the plunger chamber housing for securing the clearing system to a pump housing,
wherein a distal end of the plunger extends through a weephole located within an inner chamber of the pump housing, wherein during operation the plunger protractably engages the weephole.

8. The clearing system of claim 7, wherein the button member is fabricated from a high-impact polymer to withstand operational stresses and frequent activations.

9. The clearing system of claim 7, wherein the distal end of the plunger is made from corrosion resistant metal.

10. The clearing system of claim 7, wherein the button member is concavely contoured.

11. The clearing system of claim 7, wherein the plunger chamber housing includes an integrated mounting system to enable detachment and reattachment from the pump housing for maintenance and repair without disassembling the pump housing.

12. The clearing system of claim 7, further comprising a hydraulic actuator connected to the plunger, wherein the hydraulic actuator controls the movement of the plunger through the weephole.

13. The clearing system of claim 7, further comprising a pneumatic actuator connected to the plunger, wherein the pneumatic actuator controls translational movement of the plunger through the weephole.

14. A pump system, comprising:
a pump housing;
a clearing assembly disposed partially within the pump housing, the clearing assembly comprising a body and elongated plunger disposed at least partially in the pump housing;
a suction inlet port and a discharge outlet both in fluid communication with an inner chamber of the pump housing to facilitate a flow of operating fluid;
a weephole in the inner chamber configured to release extra fluid to regulate pressure within the inner chamber; and
the clearing assembly further comprising a plunger capable of extending into and retracting from the weephole to remove obstructions and maintain pressure regulation, wherein when the plunger is actuated, a distal end of the plunger engages with the weephole.

15. The pump system of claim 14, wherein the clearing assembly is automatically actuated by a pressure sensor responsive to predetermined fluid mechanic conditions.

16. The pump system of claim 14, wherein the clearing assembly is automatically actuated by a flowrate sensor responsive to predetermined fluid mechanic conditions.

17. The pump system of claim 14, wherein the clearing assembly further includes a manual actuation button to supplement the automatic actuation.

18. The pump system of claim 14, further comprising a plunger distal end, wherein the plunger distal end is embedded with micro-abrasives to grind away mineral deposits and other tough clogs within the weephole.

19. The pump system of claim 14, wherein the clearing assembly further comprises a mount that allows for quick release and reattachment of the plunger to facilitate maintenance and replacement of components.

20. The pump system of claim 14, further comprising an electric actuator connected to the plunger, wherein the electric actuator controls movement of the plunger through the weephole.
